(19) United States
(12) Patent Application Publication
(10) Pub. No.: US 2025/0198373 A1
(43) Pub. Date: Jun. 19, 2025

(54) INTERNAL COMBUSTION ENGINE WITH AN IMPROVED INTAKE LINE

(71) Applicant: FERRARI S.P.A., Modena (MO) (IT)

(72) Inventors: Matteo AUSILI, Modena (MO) (IT); Alessandro AGAZZI, Modena (MO) (IT); Cristiano POMPUCCI, Modena (MO) (IT); Simone DELVECCHIO, Modena (MO) (IT)

(73) Assignee: FERRARI S.P.A., Modena (MO) (IT)

(21) Appl. No.: 18/980,160

(22) Filed: Dec. 13, 2024

(30) Foreign Application Priority Data
Dec. 14, 2023 (IT) 102023000026691

(51) Int. Cl. F02M 35/10; F02M 35/12

(52) U.S. Cl. CPC F02M 35/10144; F02M 35/10; F02M 35/10137; F02M 35/1255

(57) ABSTRACT

An internal combustion engine for a motor vehicle is disclosed. The engine includes a crankcase, an intake manifold, and an intake line extending from an air intake to draw outside air to the intake manifold, the intake line comprising a connecting member arranged between the air intake and the intake manifold and comprising in turn a flexible sleeve extending along a longitudinal axis, an intake resonator attached to the flexible sleeve and extending axially along the longitudinal axis at least partially within the flexible sleeve, and a nozzle on a radially outer surface of the flexible sleeve to define an inlet orifice in the flexible sleeve.

### CROSS-REFERENCE TO RELATED PATENT APPLICATIONS

This patent application claims priority from Italian patent application no. 102023000026691 filed on Dec. 14, 2023, the entire disclosure of which is incorporated herein by reference.

### TECHNICAL FIELD

The invention concerns an internal combustion engine for a motor vehicle.

### PRIOR ART

As known, an internal combustion engine for a motor vehicle includes an intake line that brings outside air as a comburent into an intake manifold.

The intake line starts, in detail, at an air intake on the motor vehicle skin and ends in the intake manifold.

In some cases, the intake line also includes a compressor that is more generally part of a motor vehicle turbocharger.

The compressor is used to compress the air drawn through the air intake, so that the intake manifold receives air with a greater pressure than ambient pressure.

The intake line generally includes a plurality of components, optionally including parts specifically useful in cases where the compressor is included.

With specific reference to FIG. 7, illustrating an internal combustion engine 100 according to the prior art, these components include, for example, in an orderly sequence from the air intake to the intake manifold: an air filter 101, a flexible sleeve 102, a lubricating oil vapour recirculation line 103, an intercooler 104, and a resonator 105.

The air filter 101 is normally attached to a motor vehicle chassis, while the engine 100 is rather suspended from the chassis, in particular by means of elastic supports.

Therefore, the sleeve 102 is flexible precisely to compensate for the relative movement of the engine 100 with respect to the chassis and, thus, with respect to the air filter 101.

The lubricating oil vapour recirculation line 103 is configured to suck in the lubricating oil vapours formed in a lubrication apparatus of the engine 100 and to feed the sucked-in vapours into the intake manifold of the engine 100. Therefore, the lubricating oil vapour recirculation line 103 extends from the lubrication apparatus to a branch of the intake line downstream of the sleeve 102.

The intercooler 104 is a heat exchanger configured to cool the compressed air from the turbocharger compressor.

The resonator 105 is a known instrument whose function is to reduce the noise produced by air passing through the intake line and subjected to compression.

As can be seen in FIG. 7, the intake line components have a significant footprint, which has a negative impact on the motor vehicle wherein the engine 100 is installed.

In fact, the space occupied by the components of the intake line imposes design constraints, given the impossibility of using this space for the extension of the chassis or for the location of other auxiliary devices for the motor vehicle 1.

In light of the above, there is a need to reduce this negative impact, in particular by reducing the dimensions of the intake line.

One purpose of the invention is to respond to the need described above, preferably in a simple and reliable way.

### SUMMARY OF THE INVENTION

The purpose is achieved with an internal combustion engine as defined in claim 1.

The dependent claims define particular embodiments of the invention.

### BRIEF DESCRIPTION OF THE DRAWINGS

To better understand the invention, one embodiment thereof is described hereinafter by way of non-limiting example and with reference to the accompanying drawings, wherein:

FIG. 1 is a perspective view of a motor vehicle comprising an internal combustion engine according to the invention; and

FIG. 2 is a view from above of the internal combustion engine,

FIG. 3 is a perspective view, on an enlarged scale, of a connecting member of the internal combustion engine,

FIG. 4 is an exploded view of the connecting member in FIG. 3,

FIG. 5 is a longitudinal cross section of the connecting member in FIG. 3,

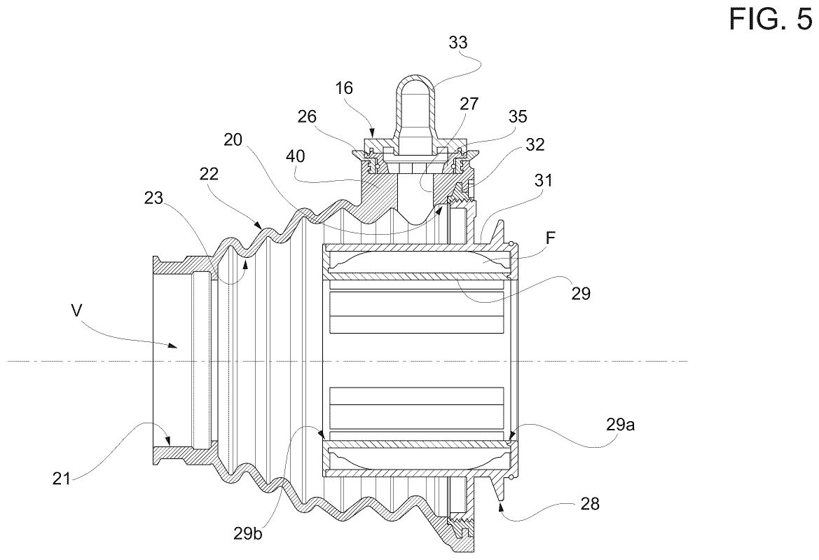

FIG. 6 is a view from above of the connecting member in FIG. 3, and

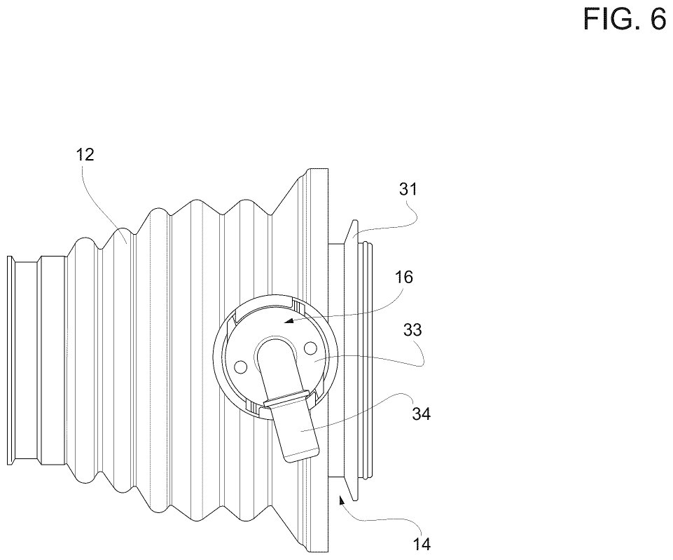

FIG. 7 is a front view of an internal combustion engine according to the prior art.

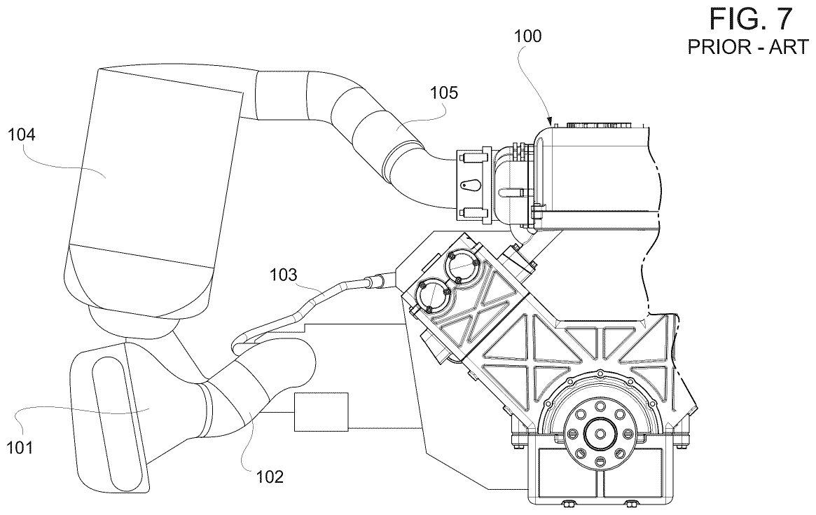

### DETAILED DESCRIPTION OF THE EMBODIMENTS

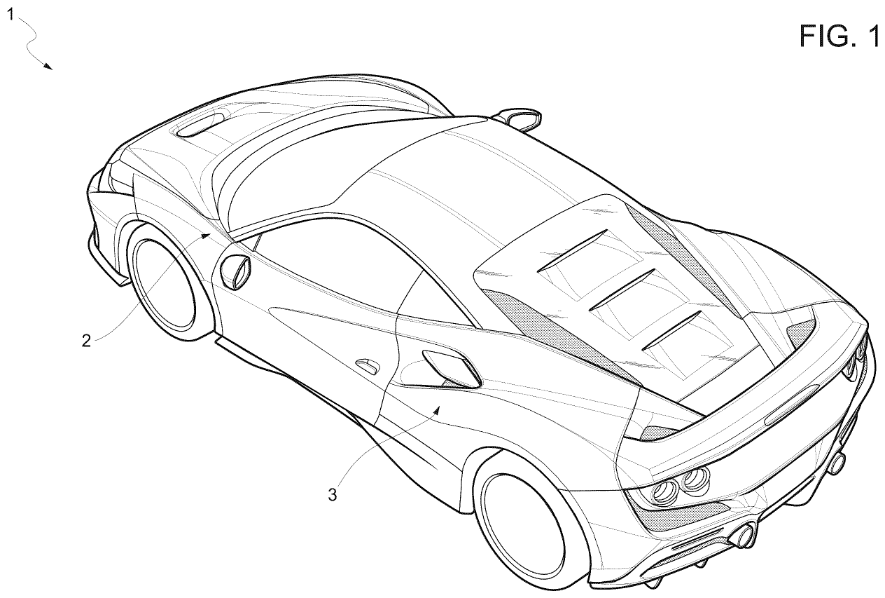

In FIG. 1, the reference number 1 is used to indicate, as a whole, a motor vehicle.

The motor vehicle 1 comprises a body 2, itself comprising a chassis (not illustrated) and a skin 3 that covers the chassis defining the external surfaces of motor vehicle 1.

In addition, the motor vehicle 1 comprises an internal combustion engine 4, which in turn comprises a crankcase 5 supported by the chassis suspended from it.

More specifically, the crankcase 5 is suspended on the chassis, especially by means of elastic suspension elements of a known type not illustrated, more specifically made of an elastomeric material.

Therefore, the crankcase 5 is coupled in a movable manner relative to the chassis, although in particular the movements of the crankcase 5 relative to the chassis elicit reactions from the suspension elements that tend to bring the crankcase 5 back to a stable equilibrium relative to the chassis.

The engine 4 also comprises an intake manifold 7 and, in detail, a plurality of cylinders (not illustrated) that communicate with the intake manifold 7 via respective intake valves to take in air collected in the intake manifold 7.

The engine 4 also includes an intake line 8 that includes an air intake 9 and extends from the air intake 9 to the intake manifold 7.

The air intake 9 is adapted to draw in outside air while the motor vehicle 1 is being used. In other words, the air intake 9 is exposed to the outside of the motor vehicle 1 and more precisely to an aerodynamic flow that is generated during the use of the motor vehicle 1 and strikes the skin 3.

The air intake 9 is in particular formed on the skin 3.

The intake line 8 is configured to conduct the air drawn through the air intake 9 to the intake manifold 7.

In detail, the air directed to the intake manifold 7 is compressed along the intake line 8, whereby the latter includes a compressor C, for example of a known type only schematically illustrated.

The compressor C is part of a turbocharger for supercharging the engine 4.

The compressor C has an inlet duct attached to the crankcase 5 and is configured to feed air into the compressor C.

The air intake 9 is fixed relative to the chassis, so the crankcase 5 and, more precisely, the compressor C may move relative to the air intake 9.

Downstream of the air intake 9, the intake line 8 preferably also includes an air filter 10 configured to filter the air drawn from the air intake 9.

Downstream of the optional air filter 10 or, in any case, downstream of the air intake 9, the intake line 8 comprises a duct 11 extending towards the inlet duct for feeding air into the compressor C, or, more generally, towards the intake manifold 7, the compressor C being an optional component.

In addition, the intake line 8 includes a flexible sleeve 12 that, in particular, connects the duct 11 to the inlet duct for feeding air into the compressor C or, more generally, to a duct attached to the crankcase 5.

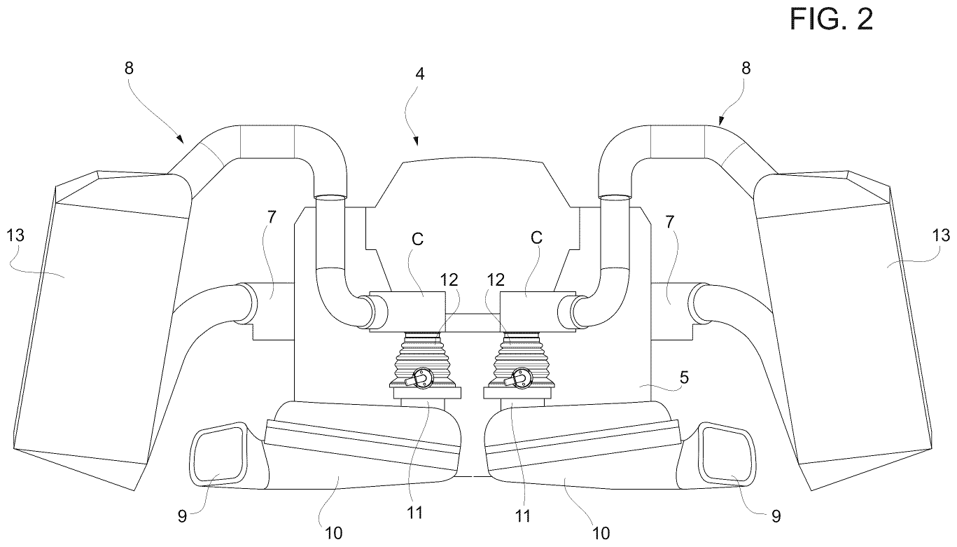

As can be seen in FIG. 2, irrespective of the other characteristics of the engine 4, the flexible sleeve 12 is most notably interposed directly or immediately between the duct 11 and the duct attached to the crankcase 5, that is, it is immediately downstream of the duct 11 and immediately upstream of the duct attached to crankcase 5.

The duct 11 is fixed relative to the air intake 9 and, thus, to the chassis, so the flexibility of the sleeve 12 allows relative movements between the crankcase 5 or the duct attached to it and the duct 11.

In other words, the sleeve 12 is more flexible than the duct 11 and the duct attached to the crankcase 5 (in particular, the inlet duct for feeding air to the compressor C).

Downstream of the compressor C, the intake line 8 optionally includes an intercooler 13 to cool the compressed air emitted by the compressor C before it reaches the intake manifold 7. The intercooler 13 is therefore arranged between the intake manifold 7 and the compressor C and may, for example, be of a known type, so its operation will not be described in further detail.

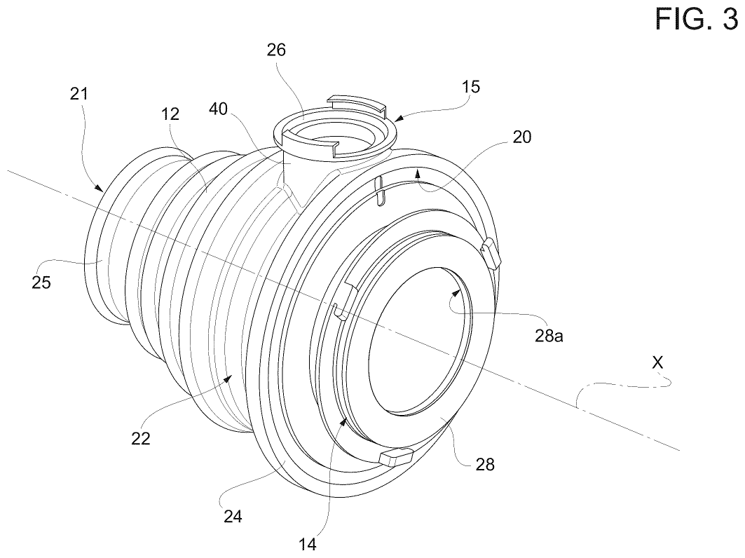

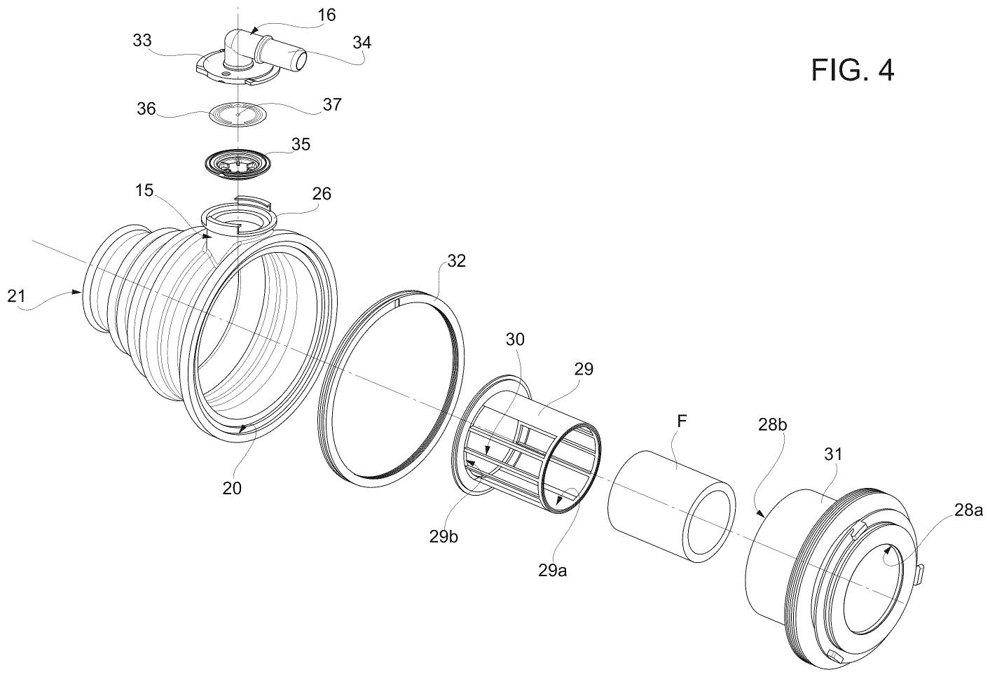

The sleeve 12 is more generally part of a connecting member (FIGS. 3, 4) of the intake line 8. This connecting member is arranged between the air intake 9 and the intake manifold 7, and more precisely between the duct 11 and the compressor C or the inlet duct for feeding air into the compressor C.

The connecting member also comprises an intake resonator 14, a nozzle 15, and, preferably, a connector 16 adapted for the connection of a duct (not shown) for recirculating lubricating oil vapours in the intake manifold 7, that is, a lubricating oil vapour recirculation duct.

The leakage of lubricating oil vapours from inside the cylinders towards the crankcase 5 is known by the English expression “blow-by”. In practice, the crankcase 5 has a vent directed towards the lubricating oil vapour recirculation duct, so that the lubricating oil vapours that leak from the cylinders can be blown from the crankcase 5 and be recirculated along the intake line 8 to the intake manifold 7.

The sleeve 12 extends along a longitudinal axis X, for example coinciding with the forward direction of the motor vehicle 1.

The sleeve 12 also extends axially, that is, along the axis X, between an inlet opening 20 and an outlet opening 21 that are opposite each other along the axis X and, respectively, closer to the air intake 9 (more precisely, to the duct 11) and to the intake manifold 7 (more precisely, to the compressor C or to the inlet duct for feeding air into the compressor C).

The sleeve 12 has a radially outer surface 22 and a radially inner surface 23; the latter defines an inner volume V of the sleeve 12.

The sleeve 12 is preferably bellows-shaped, that is, with at least one of the surfaces 22, 23, or, in detail, both the surfaces 22, 23, with an undulating or corrugated shape along the axis X.

In addition, the sleeve 12 preferably has an axially tapered shape towards the compressor C or towards the outlet opening 21; more precisely, the geometry of the sleeve 12 is axially tapered from the inlet opening 20 to the outlet opening 21.

The inlet opening 20 is defined by an axial end 24 of the sleeve 12, just as the outlet opening 21 is independently defined by an axial end 25 of the sleeve 12 opposite the axial end 24.

The axial end 25 is connected to the crankcase 5 or, more precisely, to the inlet duct for feeding air to the compressor C, so that the outlet opening 21 communicates, in detail, with this inlet duct.

The nozzle 15 defines an inlet orifice 27 in the sleeve 12. The inlet orifice 27 is therefore a through hole across the sleeve 12, in detail extending in a radial direction R with respect to the axis X. The inlet orifice 27 therefore creates a communication between the exterior of the sleeve 12 and the inner volume V. In other words, the inlet orifice 27 communicates with the inner volume V, that is, with the inside of the sleeve 12.

The sleeve 12 preferably comprises an elastomeric material or, more precisely, is made of elastomeric material.

The nozzle 15 is arranged on the radially outer surface 22. In particular, the nozzle 15 extends radially from the radially outer surface 22.

In particular, the nozzle 15 is axially closer to the inlet opening 20 than to the outlet opening 21.

In addition, more specifically, the nozzle 15 comprises a bayonet coupling body 26 for a bayonet coupling of the connector 16 to the nozzle 15.

In addition, the nozzle 15 includes a support portion 40 to which the bayonet coupling body 26 is attached. In more detail, the bayonet coupling body 26 is co-moulded with the support portion 40.

In the embodiment illustrated, the support portion 40 comprises a tubular body projecting from the radially outer surface 22 of the sleeve 12 and extending from the radially outer surface 22, in particular radially, to terminate with an end to which the bayonet coupling body 26 is attached.

However, the projecting tubular body is not strictly necessary; the support portion 40 could also have had different shapes to the one described and illustrated. For example, the support portion 40 could correspond to the bottom of a cavity in the radially outer surface 22, without loss of generality.

The bayonet coupling body 26 has a through hole with one end matching the inlet orifice 27.

The support portion 40 preferably forms a single body with the sleeve 12, whereby the support portion 28 is more preferably made of the same material as the sleeve 12.

The bayonet coupling body 26 preferably includes or is made of a plastic material that is different from that of the sleeve 12.

The resonator 14 is configured to reduce the noise produced by the air flow through the intake line 7, in particular due to the operation of the compressor C.

The resonator 14 is attached to the sleeve 12 and extends axially along the axis X at least partially inside the volume V, that is, inside the sleeve 12.

The resonator 14 comprises a radially outermost tubular body 28 and a radially innermost cage 29 coaxial and attached to the body 28.

In addition, the resonator 14 comprises sound-absorbing material F radially interposed between the body 28 and the cage 29.

The cage 29 is essentially a tubular body with radial openings 30 to allow the air flow axially crossing the cage 29 to escape into the radial gap between the body 28 and the cage 29 and then re-enter the cage 29 by interacting with the sound-absorbing material.

The operating principles of the resonator 14 are known and will not, therefore, be described in further detail.

The cage 29 and the body 28 are welded together, particularly after assembly with the sound-absorbing material.

Therefore, the resonator 14 actually comprises two tubes that are concentric and coaxial with each other, so that they are inside each other, as well as radially communicating with each other by means of the radial openings 30.

The body 28 axially terminates at its ends with two opposite openings 28a, 28b along the axis X. The same applies to the cage 29 terminating axially at its ends with two openings 29a, 29b.

The end defining the opening 29b axially plugs a circular crown portion of the opening 28b, so that the opening 29b coincides with the remaining circular portion of the opening 28b.

The same essentially applies to the end defining the opening 29a with the opening 28a, although, in detail, the radial dimension of the plugged circular crown portion is smaller.

In practice, particularly in light of the above, the resonator 14 as a whole has an axial inlet opening, coinciding, in detail, with the opening 29a, and an axial outlet opening, coinciding, in detail, with the opening 29b.

The opening 29b is arranged inside the sleeve 12, so it communicates with the inner volume V or with the inside of the sleeve 12, in particular directly.

The opening 29a is arranged in the intake line 8 to receive the air flow directed from the air intake 9 to the intake manifold 7.

Therefore, the air flow enters the resonator 14 through the opening 29a and exits it through the opening 29b, in particular by partly passing through the radial gap between the cage 29 and the body 28.

As can be seen in FIG. 3, the resonator 14 is arranged to plug the inlet opening 20 of the sleeve 12.

More specifically, the body 28 radially occupies the inlet opening 20. The body 28 is also specifically attached to the duct 11, for example by means of a bayonet coupling.

The resonator 14 is preferably glued to the radially inner surface 23, more precisely at the inlet opening 20.

In particular, the body 28 comprises an inner core 31 and a ring 32 attached to the core 31 and radially surrounding the core 31. The ring 32 has a radially inner surface attached to the core 31 and a radially outer surface glued, specifically directly, to the sleeve 12 or, more precisely, to the radially inner surface 23 thereof.

The ring 32 is preferably internally threaded, while the core 31 is externally threaded, whereby the core 31 is attached to the ring 32 by screwing on the ring 32.

The ring 32 is, for example, metallic. Independently, the body 28 and the cage 29 comprise or are made of respective plastic materials that are different to that of the sleeve 12.

The connector 16 comprises an upper element 33, in particular including a tubular element 34 with an axis having two straight portions orthogonal to each other, one of which is radial to the axis X.

The tubular element 34 can be connected to the lubricating oil vapour recirculation duct to receive the lubricating oil vapours.

The connector 16 also includes a lower element 35 bayonet-coupled to the bayonet coupling body 26.

In addition, the connector 16 includes a membrane 36 interposed between the elements 33, 35 and configured to regulate a depression across the connector 16.

The elements 33, 35 are preferably welded together with the membrane 36 sandwiched between them.

Conveniently, the elements 33, 35 comprise or are made of a plastic material different to that of the sleeve 12. The membrane 36 could be metallic and, in detail, with steel, specifically spring steel.

The connector 16 comprises a check valve, in detail comprising the elements 33, 35 and the membrane 36 interposed between them.

The check valve is configured to limit a return of the lubricating oil vapours to the lubricating oil vapour recirculation duct.

More specifically, the membrane 36 is provided with a central hole 37 calibrated to limit the return of the vapours.

From the above, the advantages of the internal combustion engine 4 according to the invention are clear.

The engine 4 connecting member combines the functions of three components that are typically separated according to the prior art, thus constituting a clear saving of space in the motor vehicle 1.

In addition, the connecting member is particularly compact both axially and radially, for example due to the insertion of the resonator 14 into the sleeve 12 and the radial integration of the nozzle 15 to the sleeve 12.

Finally, it is clear that changes may be made to the internal combustion engine 4 according to the invention, and variations produced thereof, that, in any case, do not depart from the scope of protection defined by the claims.

In particular, the number and shape of the components described and illustrated could be different.

1. An internal combustion engine for a motor vehicle, the internal combustion engine comprising a crankcase, an intake manifold, and an intake line extending from an air intake to draw outside air to the intake manifold, the intake line comprising a connecting member arranged between the air intake and the intake manifold and comprising in turn;
a flexible sleeve extending along a longitudinal axis,
an intake resonator attached to the flexible sleeve and extending axially along the longitudinal axis at least partially within the flexible sleeve, and
a nozzle on a radially outer surface of the flexible sleeve to define an inlet orifice in the flexible sleeve.

2. The internal combustion engine according to claim 1, wherein the flexible sleeve is bellows-shaped.

3. The internal combustion engine according to claim 1, wherein the intake line comprises a first duct attached to the air intake and extending towards the intake manifold downstream of the air intake, as well as a second duct attached to the crankcase, the flexible sleeve connecting the first duct to the second duct and being more flexible than the first duct and the second duct.

4. The internal combustion engine according to claim 1, wherein the nozzle extends radially from the radially outer surface of the flexible sleeve.

5. The internal combustion engine according to claim 1, wherein the connecting member further comprises a connector attached to the nozzle and adapted for connecting a conduit for a recirculation in the intake manifold of lubricating oil vapours.

6. The internal combustion engine according to claim 5, wherein the connector comprises a check valve for limiting a return of lubricating oil vapours to said conduit.

7. The internal combustion engine according to claim 5, wherein the nozzle comprises a bayonet coupling body for a bayonet coupling of the connector to the nozzle.

8. The internal combustion engine according to claim 7, wherein the nozzle further comprises a support portion co-moulded with the bayonet coupling body.

9. The internal combustion engine according to claim 1, wherein the intake resonator has an axial inlet opening and an axial outlet opening opposite the axial inlet opening according to the longitudinal axis, the axial outlet opening being arranged within the flexible sleeve, and wherein the axial inlet opening is arranged to receive an airflow directed from the air intake to the intake manifold, so that the airflow enters the intake resonator through the axial inlet opening and exits the intake resonator into the flexible sleeve through the axial outlet opening.

10. The internal combustion engine according to claim 9, wherein the intake resonator is arranged to plug an axial inlet opening of the flexible sleeve.

11. The internal combustion engine according to claim 1, wherein the intake resonator is bonded to a radially inner surface of the flexible sleeve.

12. The internal combustion engine according to claim 1, wherein the flexible sleeve is bellows-shaped.

13. The internal combustion engine according to claim 1, wherein the flexible sleeve is axially tapered toward the intake manifold.

14. A motor vehicle comprising a chassis and an internal combustion engine according to claim 1, wherein the air intake is fixed relative to the chassis, and wherein the crankcase is suspended on the chassis.
